(19) United States
(12) Patent Application Publication
(10) Pub. No.: US 2025/0276494 A1
(43) Pub. Date: Sep. 4, 2025

(54) POWDER CONTROL FOR ADDITIVE MANUFACTURING SYSTEMS

(71) Applicants: Rolls-Royce Corporation, Indianapolis, IN (US); Rolls-Royce plc, London (GB)

(72) Inventors: Scott Nelson, Indianapolis, IN (US); David James Puhl, Indianapolis, IN (US); Clive Grafton-Reed, London (GB); Peter E. Daum, Indianapolis, IN (US); Robert F. Proctor, Indianapolis, IN (US); Christopher Paul Heason, London (GB)

(21) Appl. No.: 18/593,465

(22) Filed: Mar. 1, 2024

(51) Int. Cl. B29C 64/393; B29C 64/153; B29C 64/343; B33Y 10/00; B33Y 30/00; B33Y 50/02

(52) U.S. Cl. CPC B29C 64/393; B29C 64/153; B29C 64/343; B33Y 10/00; B33Y 30/00; B33Y 50/02

(57) ABSTRACT

An additive manufacturing system includes an energy delivery device configured to deliver energy to a build surface of a component to form a melt pool in the build surface of the component, a powder delivery device configured to direct a powder stream toward the melt pool, at least one sensor configured to generate sensor data representative of at least one process characteristic, and a computing device. The computing device is configured to receive the sensor data from the at least one sensor, determine, based on the sensor data and a predictive model data, at least one powder control parameter configured to achieve a predetermined powder feed rate of the powder stream, and control, based on the at least one powder control parameter, the energy delivery device and the powder delivery device to deposit a plurality of layers.

### TECHNICAL FIELD

The disclosure relates to additive manufacturing techniques.

### BACKGROUND

Additive manufacturing generates three-dimensional structures through addition of material layer-by-layer or volume-by-volume to form the structure, rather than removing material from an existing component to generate the three-dimensional structure. Additive manufacturing may be advantageous in many situations, such as rapid prototyping, forming components with complex three-dimensional structures, or the like. In some examples, additive manufacturing may utilize powdered materials and may melt or sinter the powdered material together in predetermined shapes to form the three-dimensional structures. In addition to initial fabrication, additive manufacturing techniques may include subsequent machining processes to finish a component.

### SUMMARY

The disclosure describes additive manufacturing systems, and methods for operating additive manufacturing systems, that monitor and control powder flow to influence additive process parameters. For example, powder feed rate affects process responses of an additive manufacturing process. At the same time, powder control parameters (e.g., powder size, powder density, carrier gas flow rate, or other parameters) and process characteristics (e.g., melt pool size) also affect powder flow. Thus, a predictive model may be used to predict, monitor, and/or control powder feed rate, accounting for other parameters and characteristics, to achieve a predetermined powder feed rate of the powder stream. In this way, the additive manufacturing systems described herein may enable more efficient use of powder in additive fabrication of a component.

In some examples, the disclosure describes an additive manufacturing system that includes an energy delivery device, a powder delivery device, at least one sensor, and a computing device. The energy delivery device is configured to deliver energy to a build surface of a component to form a melt pool in the build surface of the component. The powder delivery device is configured to direct a powder stream toward the melt pool. The at least one sensor is configured to generate sensor data representative of at least one process characteristic. The computing device is configured to receive the sensor data from the at least one sensor. The computing device is further configured to determine, based on the sensor data and a predictive model data, at least one powder control parameter configured to achieve a predetermined powder feed rate of the powder stream. The computing device is further configured to control, based on the at least one powder control parameter, the energy delivery device and the powder delivery device to deposit a plurality of layers.

In some examples, the disclosure describes a method that includes receiving, by a computing device, sensor data for a plurality of layers from at least one sensor of an additive manufacturing system, where the sensor data is representative of at least one process characteristic. The method may further include determining, by the computing device, based on the sensor data and a predictive model data, at least one powder control parameter configured to achieve a predetermined powder feed rate of the powder stream. The method may further include controlling, by the computing device, based on the at least one powder control parameter, an energy delivery device to deliver energy to a build surface to form a melt pool and a powder delivery device to direct a powder stream toward the melt pool.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating powder monitoring aspects of an example additive manufacturing system that includes a sensor configured to monitor at least one process characteristic of the additive manufacturing system during an additive manufacturing technique.

FIG. 2 is a conceptual and schematic diagram illustrating an example powder flow monitoring system configured to monitor powder flow between a powder delivery device and a build surface during the additive manufacturing technique.

FIG. 3 is a process flow diagram illustrating a mass flux and heat flux monitoring and control technique.

FIG. 4 is a flowchart illustrating an example technique for fabricating a component while controlling a powder feed rate.

FIG. 5A is a conceptual diagram illustrating an example machine learning model.

FIG. 5B is a conceptual diagram illustrating an example training process for a machine learning model.

### DETAILED DESCRIPTION

The disclosure generally describes techniques and systems for monitoring process characteristics indicative of powder feed rate during a blown powder additive manufacturing technique (e.g., directed energy deposition, DED), and controlling process characteristics based on a predictive model to achieve a predetermined powder feed rate. For example, the predetermined powder feed rate may promote capture of powder by a melt pool, and reduce underutilization of powder. Further, excess powder not captured by the melt pool may tend to collect in restricted, constrained, or narrow portions or regions of a component. Such collection of excess powder may increase machine wear and tear, loss of powder, and deviation from operational tolerances. Controlling the powder feed rate to promote capture of a substantial portion of the powder by the melt pool, for example, substantially all powder by the melt pool (and eventually, into a fabricated component) may thus reduce material costs, processing costs, and machine maintenance and downtime.

During blown powder additive manufacturing, a component is built up by adding material to the component in sequential layers, such that the final component is composed of a plurality of layers of material. In blown powder additive manufacturing techniques for forming components from metals or alloys, an energy source may direct energy at a substrate to form a melt pool, and a powder delivery device may deliver a powder to the melt pool. At least some of the powder at least partially melts and is joined to the melt pool and, thus, the substrate.

Powder feed rate is a parameter that affects many process responses, such as build quality, build height, layer thickness, and additive processes may attempt to utilize a powder feed rate that promotes capture of substantially all powder directed to a melt pool by the melt pool, and ultimately, incorporation into a fabricated component. Excess powder may collect in constrained, narrow, or tight regions of components or substrates in additive manufacturing systems, which may affect efficiency, component life, product quality, and economical considerations.

Powder flow monitoring system and/or upstream powder monitoring such as gravimetric monitoring, and powder quality monitoring may be used to characterize the responsiveness of changing a powder feed rate, accounting for powder control parameters or variables (e.g., powder feeders, deposition heads, powder sizes, powder densities, machine designs, or carrier gas flow rates). A predictive model may be generated and used to predict, control, and or monitor powder feed rate. For example, a modeled powder feed rate behavior may be used to determine mass flux based on part geometry (e.g., using deposit topology), melt pool capture capability (e.g., using melt pool size monitoring), and build strategy.

In accordance with techniques of this disclosure, an additive manufacturing system may include at least one sensor for measuring at least one process characteristic. By monitoring at least one process characteristic indicative of powder feed rate, the systems described herein may enable a more efficient use of powder in fabricating a component, more effectively and/or efficiently control operation of the machining device. For example, the at least one process characteristic and a predictive model may be used to control at least one powder control parameter configured to achieve a predetermined powder feed rate of the powder stream. The predetermined powder feed rate may promote utilization of powder into the component, and reduce loss or underutilization of powder.

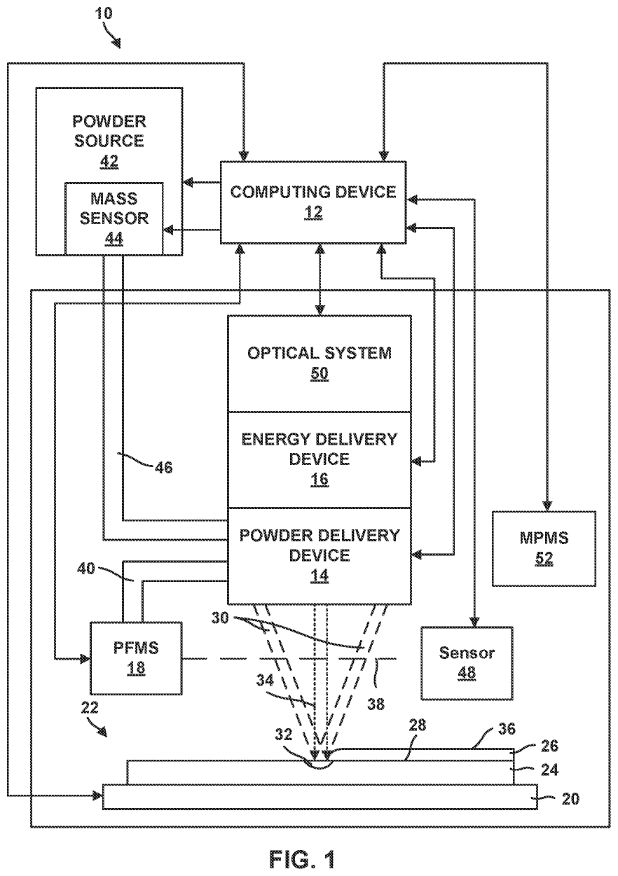

FIG. 1 is a conceptual block diagram illustrating an example additive manufacturing system 10 configured to monitor and control a powder feed rate of a powder used to fabricate a component 22 during an additive manufacturing technique. In the example illustrated in FIG. 1, additive manufacturing system 10 includes a computing device 12, a powder delivery device 14, an energy delivery device 16, a powder flow monitoring system (PFMS) 18, a stage 20, an optical system 50, a melt pool monitoring system (MPMS) 52, a powder source 42, a powder source mass sensor 44, and a sensor 48.

Stage 20 is configured to position component 22 during an additive manufacturing process. In some examples, stage 20 is movable relative to energy delivery device 16 and/or energy delivery device 16 is movable relative to stage 20. Similarly, stage 20 may be movable relative to powder delivery device 14 and/or powder delivery device 14 may be movable relative to stage 20. Stage 20 may be configured to selectively position and restrain component 22 in place relative to stage 20 during manufacturing of component 22.

Powder source 42 is the source of powder for powder stream 30. Powder source 42 may include any suitable container or enclosure, such as a hopper, configured to hold powder. Powder source 42 also may include a mechanism for entraining the powder in a gas flow. For instance, powder source 42 may be coupled to a gas source, which provides a gas flowing through powder source 42 and entraining powder within the gas flow. Additionally, or alternatively, powder source 42 may include an agitator configured to agitate the powder and increase entrainment of the powder in the gas stream. System 10 may include a powder source mass sensor 44 associated with powder source 42. Powder source mass sensor 44 may be configured to quantify loss of mass in the powder source 42 or, alternatively, a mass flow out of powder source 42.

Powder source 42 is fluidically coupled to powder delivery device 14 via a flow path 46. Flow path 46 may include any suitable structure(s) defining an enclosed flow between powder source 42 and powder delivery device, including conduit, pipe, tubes, or the like. Although not shown in FIG. 1, for at least part of flow path 46 between powder source 42 and nozzles of powder delivery device 14, flow path 46 may split into multiple, parallel sections, e.g., one for each nozzle. Further, although not shown in FIG. 1, in some examples, flow path 46 may include one or more nozzles for controlling flow through flow path 46 as a whole or portions of flow path 46 (e.g., a section associated with a particular nozzle of powder delivery device 14).

Powder delivery device 14 may be configured to deliver powder to selected locations of component 22 being formed via a powder stream 30. Powder delivery device 14 may include one or more nozzles that each output powder, such that the combined powder defines powder stream 30 focused at a focus plane. As powder delivery device 14 is movable in the z-axis shown in FIG. 1 relative to component 22, the focal plane of powder delivery device 14 also may be movable in the z-axis relative to component 22, such that the focus plane may be controlled to be substantially coincident with a build surface 28 of component 22.

In some examples, powder delivery device 14 may be mechanically coupled or attached to energy delivery device 16 to facilitate delivery of powder stream 30 and energy 34 for forming melt pool 32 to substantially the same location adjacent to component 22. Energy delivery device 16 may include an energy source, such as a laser source, an electron beam source, plasma source, or another source of energy 34 that may be absorbed by component 22 to form a melt pool 32 and/or be absorbed by powder in powder stream 30 to be added to component 22. Example laser sources include a CO laser, a CO₂ laser, a Nd:YAG laser, or the like. In some examples, the energy source may be selected to provide energy with a predetermined wavelength or wavelength spectrum that may be absorbed by component 22 and/or the powder to be added to component 22 during the additive manufacturing technique.

In some examples, energy delivery device 16 also includes an energy delivery head, which is operatively connected to the energy source. The energy delivery head may aim, focus, or direct energy 34 toward predetermined positions at or adjacent to a surface of component 22 during the additive manufacturing technique. As described above, in some examples, the energy delivery head may be movable in at least one dimension (e.g., translatable and/or rotatable) under control of computing device 12 to direct the energy toward a selected location at or adjacent to a surface of component 22.

As shown in FIG. 1, energy delivery device 16 may be arranged or configured such that energy 34 and powder stream 30 both exit from a common deposition head and are directed toward build surface 28. For instance, energy 34 may pass through a central channel within the deposition head and exit a central aperture in the deposition head, while fluidized powder may flow through internal channels and powder nozzle(s) for forming powder stream 30 and directing powder stream 30 toward build surface 28. At least some of the powder in powder stream 30 may impact a melt pool 32 in component 22, and at least some of the powder that impacts melt pool 32 may be joined to component 22.

During additive manufacturing, component 22 is built up by adding material to component 22 in sequential layers. The final component is composed of a plurality of layers of material. Energy delivery device 16 may direct energy 34 at first layer 24 to form melt pool 32. Powder delivery device 14 may deliver powder stream 30 to melt pool 32, where at least some of the powder at least partially melts and is joined to first layer 24. Melt pool 32 cools as energy 34 is no longer delivered to that location of first layer 24 (e.g., due to energy delivery device 16 scanning energy 34 over the surface of first layer 24). The temperature and cooling rate of melt pool 32 and the surrounding areas of first layer 24 affect the microstructure of the component 22 formed using the additive manufacturing technique.

System 10 may include both mass flow monitoring and heat flow monitoring. To provide mass flow monitoring, system 10 may include powder flow monitoring system (PFMS) 18. PFMS 18 is configured to image at least a portion of powder stream 30 to detect powder flowing between powder delivery device 14 and build surface 28. For example, PFMS 18 may include an illumination device and an imaging device. In some examples, the illumination device may include one or more light sources. For instance, the illumination device may include one or more structured light devices, such as one or more lasers. The illumination device is configured to illuminate a plane of powder stream 30 at image plane 38, e.g., a plane substantially perpendicular to an axis extending between powder delivery device 14 and build surface 28. The imaging device of PFMS 18 is configured to image at least some of the illuminated powder. The imaging device may have a relatively high data acquisition speed (e.g., frame rate), such as greater than 1000 Hz. To provide heat flow monitoring, system 10 may include melt pool monitoring system (MPMS) 52. MPMS 52 is configured to image at least a portion of melt pool 32 to detect parameters, such as size, temperature, or shape, of melt pool 32. For example, MPMS may be communicatively coupled to optical system 50 for observing thermal emissions around melt pool 32 and a thermal camera for monitoring a size and/or temperature of melt pool 32.

Optical system 50 may include an imaging device and an associated optical train, which senses emissions at or near component 22 during the additive manufacturing technique. For example, optical system 50 may include a visible light imaging device, an infrared imaging device, or an imaging device that is configured (e.g., using a filter) to image a specific wavelength or wavelength range. The optical train may include one or more reflective, refractive, diffractive optical components configured to direct light to the imaging device. For example, the optical train may be configured to direct light from near component 22 and/or melt pool 32 to the imaging device.

System 10 further includes at least one sensor 48. Sensor 48 may be configured to generate sensor data representative of at least one process characteristic of a process performed by system 10. For example, the at least one process characteristic may include at least one of a powder flow rate, a carrier gas flow rate, a melt pool size, a powder quality, a powder velocity. Sensor 48 may include at least one of a powder flow monitor, a gas flow sensor, a melt pool monitor, a high speed camera, or a laser diffraction sensor.

Computing device 12 is configured to control components and operation of system 10 and may include, for example, a desktop computer, a laptop computer, a workstation, a server, a mainframe, a cloud computing system, or the like. Computing device 12 may be communicatively coupled to, and configured to control, powder delivery device 14, energy delivery device 16, PFMS 18, optical system 50, MPMS 52, stage 20, powder source 42, powder source mass sensor 44, and/or sensor 48 using respective communication connections. Although FIG. 1 illustrates a single computing device 12 and attributes all control and processing functions to that single computing device 12, in other examples, system 10 may include multiple computing devices 12, e.g., a plurality of computing devices 12.

Computing device 12 may be configured to control operation of powder delivery device 14, energy delivery device 16, adjustable z-stage 40, stage 20, and/or sensor 48 to position component 22 relative to powder delivery device 14, energy delivery device 16, PFMS 18, MPMS 52, and/or sensor 48 during additive manufacturing processes. For example, as described above, computing device 12 may control stage 20 and powder delivery device 14, energy delivery device 16, adjustable z-stage 40 and/or powder flow sensor to translate and/or rotate along at least one axis to position component 22 relative to powder delivery device 14, energy delivery device 16, PFMS 18, MPMS 52, and/or sensor 48. Positioning component 22 relative to powder delivery device 14, energy delivery device 16, PFMS 18, MPMS 52, and/or sensor 48 may include positioning a predetermined surface (e.g., a surface to which material is to be added) of component 22 in a predetermined orientation relative to powder delivery device 14, energy delivery device 16, PFMS 18, MPMS 52, and/or sensor 48.

Computing device 12 may be configured to control system 10 to deposit layers 24 and 26 to form component 22 based on a set of deposition parameters. The set of deposition parameters may include energy, feed, and motion parameters that are configured to produce layers 24, 26, having various physical parameters, such as a height of layers 24, 26, and a density of layers 24, 26. For example, the set of deposition parameters may include power, beam diameter, beam profile, and wavelength of energy delivery device 16; powder feed rate and gas feed rate of powder delivery device 14; scan speed and deposition path of stage 20 relative to energy delivery device 16 and powder delivery device 14; or any other operating parameters that may affect an amount and/or quality of material formed as layers 24, 26.

Computing device 12 may be configured to select deposition parameters that are configured to generate layers 24, 26, according to predetermined physical parameters. As shown in FIG. 1, component 22 may include a first layer 24 and a second layer 26, although many components may be formed of additional layers, such as tens of layers, hundreds of layers, thousands of layers, or the like. Component 22 in FIG. 1 is simplified in geometry and the number of layers compared to many components formed using additive manufacturing techniques. Although techniques are described herein with respect to component 22 including first layer 24 and second layer 26, the technique may be extended to components 22 with more complex geometry and any number of layers.

To form component 22, computing device 12 may control powder delivery device 14 and energy delivery device 16 according to the set of operating parameters to form, on a surface 28 of first layer 24 of material, a second layer 26 of material. Computing device 12 may control energy delivery device 16 to deliver energy 34 to a volume at or near surface 28 to form melt pool 32. For example, computing device 12 may control the relative position of energy delivery device 16 and stage 20 to direct energy to the volume. Computing device 12 also may control powder delivery device 14 to deliver powder stream 30 to melt pool 32. For example, computing device 12 may control the relative position of powder delivery device 14 and stage 20 to direct powder stream 30 at or on to melt pool 32.

Computing device 12 may control powder delivery device 14 and energy delivery device 16 to move energy 34 and powder stream 30 along build surface 28 in a pattern until layer 26 is complete. Computing device 12 may then control a z-axis position of stage 20 and/or powder delivery device 14 and energy delivery device 16 such that melt pool 32 will be formed on surface 36 of second layer 26, and may control powder delivery device 14 and energy delivery device 16 to move energy 34 and powder stream 30 along build surface 28 in a pattern until layer 26 is complete.

Computing device 12 may use sensor data from sensor 48 (alone, or in combination with sensor data from at least one other sensor) to control powder flow in system 10, for example, to control a powder feed rate. For example, computing device 12 may be configured to receive sensor data from sensor 48 representative of at least one process characteristic. The at least one process characteristic may include any suitable process characteristic that may be associated with powder feed rate, including, for example, at least one of a powder flow rate, a carrier gas flow rate, a melt pool size, a powder quality, or a powder velocity. Computing device 12 may be further configured to determine, based on the sensor data and a predictive model data, at least one powder control parameter configured to achieve a predetermined powder feed rate of powder stream 30. The predictive model data may be based on historical data or cohort data obtained from runs of system 10 or of other systems in which at least one powder control parameter influences a powder feed rate in system 10 having at least one process characteristic. For example, powder control parameters and may be varied, and the effect of changing one or more powder control parameters on powder feed rate may be measured and recorded for different magnitudes of process characteristics.

Computing device 12 (or some other computing device) may generate the predictive model based on powder control parameters, the process characteristics, and powder feed rates. For example, a machine learning model may be trained using any of powder control parameters, process characteristics, and powder feed rate as inputs or outputs, such that for a given combination of two of a powder control parameter, a process characteristic, and a powder feed rate, a third of the powder control parameter, a process characteristic, and a powder feed rate may be predicted. Thus, the trained machine learning model may be used as the predictive model. For example, computing device 12 may use sensor data from sensor 48 (indicative of at least one process characteristic) and a predetermined powder feed rate as inputs to the predictive model, and may determine at least one powder control parameter as an output of the predictive model. Accordingly, for a given process characteristic and a predetermined powder feed rate, computing device 12 may determine an appropriate value for the powder control parameter. Further, the predictive model may be used to determine either specific values, or ranges of values, for the powder control parameter, based on specific values, ranges or values, and tolerances, for at least one process characteristic and powder feed rate.

In some examples, computing device 12 itself generates the predictive model based on historical runs of system 10. For example, computing device 12 may be further configured to generate the predictive model data by determining a change in the powder feed rate or some other parameter associated with a change in the at least one powder control parameter. The other parameter may include at least one of carrier velocity, center purge gas velocity, particle velocity, powder stream profile, working powder spot size, working powder spot shape, working powder spot density profile, or nozzle type and geometry.

In other examples, the predictive model is generated by another computing device based on runs of other systems, or based on component modeling of system 10.

The at least one powder control parameter may include, for example, at least one of a powder flow rate, a powder size, a powder density, a powder feeder geometry, a deposition head geometry, a carrier gas flow rate, a powder nozzle geometry, a center purge shielding gas flow rate, a nozzle standoff to substrate distance, a nozzle standoff to build surface distance, or any parameter that may affect the powder stream or powder working spot size, shape, or density profile.

Computing device 12 may be further configured to control, based on the at least one powder control parameter, energy delivery device 16 and powder delivery device 14, to deposit a plurality of layers to form component 22. Thus, computing device 12 may control or vary the at least one powder control parameter to ultimately achieve the predetermined powder feed rate. For example, the predetermined powder feed rate may promote the utilization of powder contacting melt pool 32 and being incorporated into component 22, and thus reduce loss or underutilization of powder originating from powder source 42.

Computing device 12 may be further configured to account for at least one component interaction parameter in determining a mass flux. For example, computing device 12 may be configured to determine, based on the at least one powder control parameter and at least one component interaction parameter, a mass flux; and control, based on the at least one powder control parameter and the mass flux, energy delivery device 16 and powder delivery device 14 to deposit the plurality of layers. The at least one component interaction parameter may be indicative of an interaction of one or both of powder or energy with melt pool 32, or with component 22, in course of additive manufacturing. For example, the at least one component interaction parameter may include at least one of a part geometry, a melt pool capture capability, or a tool path. Further, computing device 12 may be configured to determine at least one of the part geometry based on a deposit topology, the melt pool capture capability based on melt pool size, or the tool path based on a build strategy associated with component 22.

Computing device 12 may also use sensor data from sensor 48 to determine a quality of component 22, for example, conformance of or deviation of component 22 compared to geometric tolerances. For example, computing device 12 may be further configured to determine, based on the sensor data, at least one process response, and determine, by comparing the process response with a threshold response value, a quality index. The at least one process response may be indicative of an aspect of component 22 influenced by a process performed by system 10. For example, the at least one process response may include at least one of a build quality, a build height, or a layer thickness.

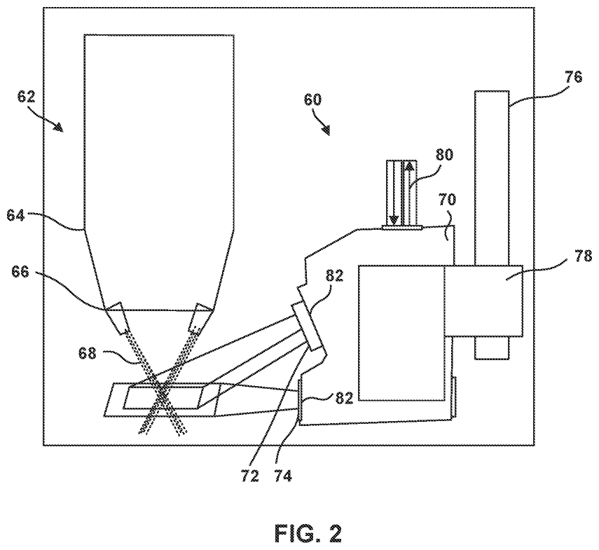

FIG. 2 is a conceptual and schematic diagram illustrating an example powder flow monitoring system (PFMS) 60 configured to monitor powder flow between a powder delivery device 62 and a build surface (not shown in FIG. 2) during an additive manufacturing technique. Powder delivery device 62 may be an example of powder delivery device 14 of FIG. 1, and PFMS 60 may be an example of PFMS 18 of FIG. 1.

Powder delivery device 62 includes a deposition head 64 that carries a plurality of powder nozzles 66. Plurality of powder nozzles 66 output a powder stream 68 toward the build surface. As shown in FIG. 2, powder stream 68 may be focused at a focal plane, such that powder stream 68 is converging toward the focal plane and diverging away from the focal plane.

PFMS 60 includes a housing 70 (also referred to as an enclosure), which encloses an imaging device 72 and an illumination device 74. In some examples, imaging device 72 may be a high-speed camera and illumination device 74 may be laser illuminator. Housing 70 is attached to an adjustable z-stage 76 by a bracket 78.

Housing 70 is configured to enclose imaging device 72 and illumination device 74 and help protect imaging device 72 and illumination device 74 from a surrounding environment. For instance, housing 70 may be configured to surround imaging device 72 and illumination device 74 and prevent any powder that reflects from the build surface toward PFMS 60 from impacting imaging device 72 or illumination device 74.

Further, housing 70 may be configured to cool imaging device 72 and illumination device 74. Imaging device 72 and illumination device 74 may be exposed to heat from the melt pool at the build surface and energy from the energy delivery device. Imaging device 72 and illumination device 74 may be relatively sensitive to heat and have improved operational lifetime if maintained and operated below a certain temperature. PFMS 60 may include a cooling system 80 configured to remove heat from within housing 70 to cool imaging device 72 and illumination device 74. For instance, cooling system 80 may include cooling fluid circuit through which a cooling fluid flows, and housing 70 may include part of the cooling circuit. In some examples, housing 70 may be formed from a material having relatively high thermal conductivity, such as aluminum, to help transfer heat from within housing 70 to cooling system 80 (e.g., a cooling fluid flowing through cooling system 80).

As described above, PFMS 60 may be configured to measure powder flow of powder stream 68 (FIG. 2) at one or more axial (or longitudinal) locations of powder stream 68 and determine one or more parameters associated with the powder flow. For instance, illumination device 74 may illuminate powder of powder stream 68 in a plane oriented substantially orthogonal to a longitudinal axis that extends from powder delivery device 62 to the build surface. PFMS 60 may be positioned at a selected axial or longitudinal location to image a selected axial or longitudinal position between powder delivery device 62 and the build surface. Imaging device 72 may be configured to image at least some of the illuminated powder.

System 10 may be configured with various in-situ monitoring techniques, including powder flow monitoring, mass flux monitoring, and heat flux monitoring, to control an additive manufacturing process.

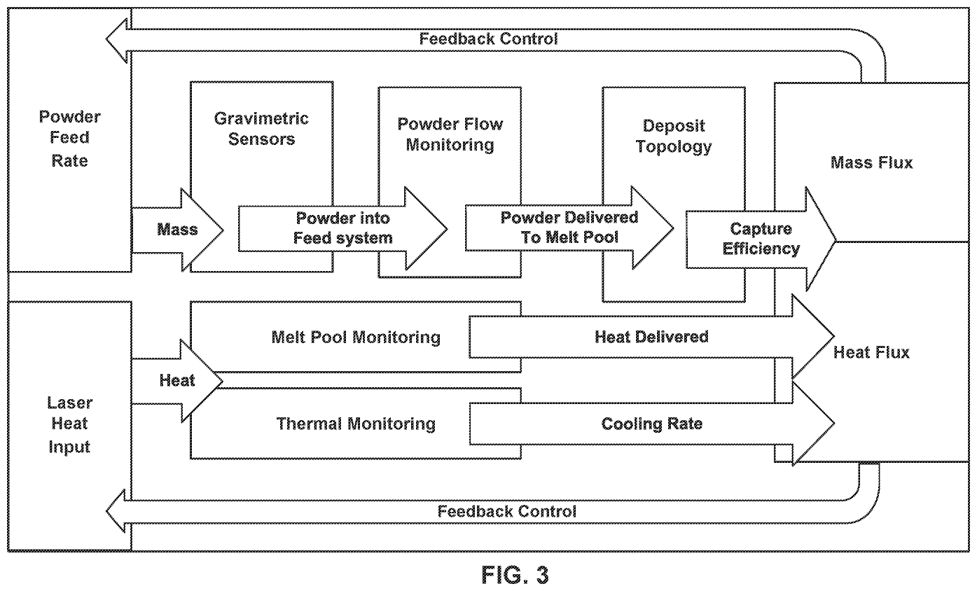

FIG. 3 is a process flow diagram illustrating a mass flux and heat flux monitoring and control technique. The technique of FIG. 3 may be implemented by system 10 of FIG. 1 or system 60 of FIG. 2 and will be described with concurrent reference to FIGS. 1 and 2. However, it will be appreciated that system 10 may perform other techniques and the technique of FIG. 3 may be performed by other systems.

Computing device 12 may be configured to control a powder feed rate output by powder source 42 (see top left of FIG. 3). For instance, computing device 12 may be configured to control an agitator of powder source 42, a gas flow rate of gas flowing through powder source 42, a position of one or more valves within flow path 46, or the like to control a powder feed rate output by powder source 42.

Computing device 12 may be configured to receive data from one or more mass flow monitoring sensors, including PFMS 18 and/or powder source mass sensor 44. Data received from powder source mass sensor 44 indicates a mass flow of powder from powder source 42 to powder delivery device. Data from PFMS 18 indicates a mass flow of powder in powder stream 30 between powder delivery device 14 to adjacent melt pool 32. In some examples computing device 12 may be configured to further receive powder flow data from sensor 48. For example, sensor 48 may include a powder flow sensor, and data from sensor 48 may indicate a topology of build surface 28, and may further indicate powder mass captured by melt pool 32 and added to component 22.

Computing device 12 may calculate one or more mass flow-related metrics based on the data received from PFMS 18, powder source mass sensor 44, and/or sensor 48. For example, computing device 12 may determine a capture efficiency by determining a fraction or percentage of powder from powder stream 30 that is captured by melt pool 32 and added to component 22, e.g., by dividing the powder mass captured by melt pool 32, as determined based on data from powder flow sensor, into the mass flow determined based on data received from PFMS 18. Further, computing device 12 may determine an overall mass flux using the data received from PFMS 18, powder source mass sensor 44, and/or sensor 48. Computing device 12 then may use the overall mass flux as an input to the control algorithm used to control the powder feed rate output by powder source 42 (see top left of FIG. 3).

Similarly, computing device may be configured to control energy delivery device 16 to deliver energy 34 to first layer 24 to establish a given heat input (see bottom left of FIG. 3). For example, one or more computing device 12 may control one or more operating parameters of energy delivery device 16, such as intensity, pulse rate, pulse width, or the like; one or more positional parameters related to energy delivery device 16, such as dwell time at a location, a movement rate relative to first layer 24, an overlap between adjacent passes of energy 34 across first layer 24, a pause time between adjacent passes of energy 34 across first layer 24, or the like to control heat input to system 10 (e.g., to melt pool 32 and component 22).

Computing device 12 may be configured to receive data from one or more heat sensors, such as optical system 50 and/or MPMS 52. Computing device 12 may determine a cooling rate and associated heat from using data from optical system 50 and may determine a heat input into component using a size and/or temperature of melt pool 32 as observed by melt pool monitor. Computing device 12 may be configured to determine an overall heat flux using these data. Computing device 12 may then use the overall heat flux as an input to the control algorithm used to control the energy delivery by energy delivery device 16 (see bottom left of FIG. 3). In some examples, computing device 12 may also use a deposit topology (captured powder mass) and/or capture efficiency metric in the determination of the heat flux, as the added powder mass and quench effects associated with the captured powder affect the cooling rate.

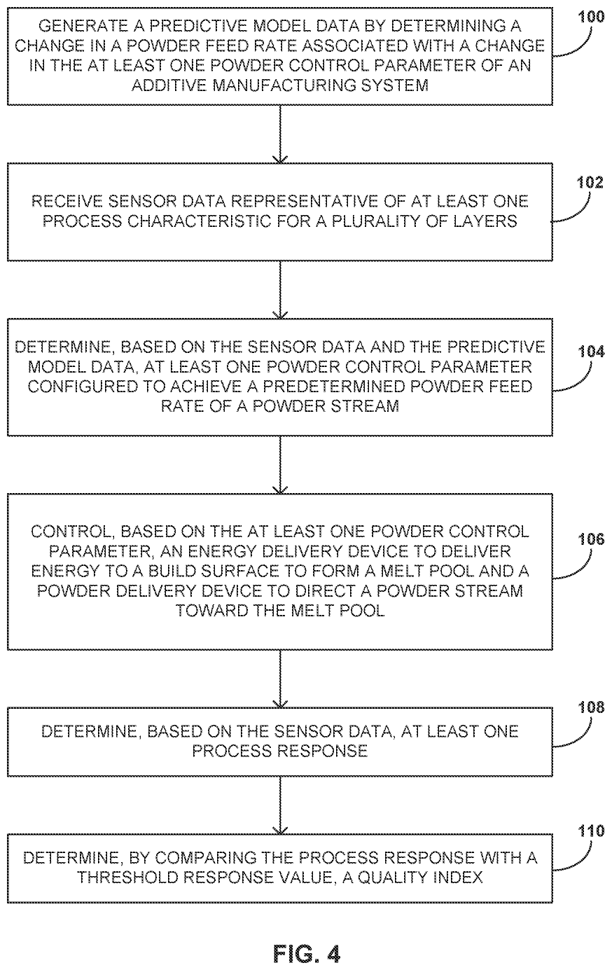

FIG. 4 is a flowchart illustrating an example technique for fabricating a component while controlling a powder feed rate. The technique of FIG. 4 may be implemented by system 10 of FIG. 1 or system 60 of FIG. 2 and will be described with concurrent reference to FIGS. 1 and 2. However, it will be appreciated that system 10 may perform other techniques and the technique of FIG. 3 may be performed by other systems.

In some examples, the technique of FIG. 4 includes receiving, by computing device 12, sensor data for a plurality of layers from at least one sensor 48 of additive manufacturing system 10 (102). The sensor data is representative of at least one process characteristic (associated with a process performed by system 10). The at least one process characteristic may include at least one of a powder flow rate, a carrier gas flow rate, a melt pool size, a powder quality, or a powder velocity.

The technique may further include determining, by computing device 12, based on the sensor data and a predictive model data, at least one powder control parameter configured to achieve a predetermined powder feed rate of powder stream 30 (104). The at least one powder control parameter may include at least one of a powder flow rate, a powder size, a powder density, a powder feeder geometry, a deposition head geometry, a carrier gas flow rate, a powder nozzle geometry, a center purge shielding gas flow rate, a nozzle standoff to substrate distance, a nozzle standoff to build surface distance, or any parameter that may affect the powder stream or powder working spot size, shape, or density profile.

The technique may further include controlling, by computing device 12, based on the at least one powder control parameter, energy delivery device 16 to deliver energy 34 to build surface 28 to form melt pool 32 and powder delivery device 14 to direct powder stream 30 toward melt pool 32 (106).

The predictive model data may be generated by computing device 12 or any other computing device. In some examples, the technique includes, by computing device 12, generating the predictive model data by determining a change in the powder feed rate associated with a change in the at least one powder control parameter (100). Alternatively, computing device 12 may receive the predictive model data from another computing device, a server, a network, a memory storage device, or from a database.

The controlling (106) may include, or be augmented by, determining other parameters of system 10. For example, the technique may further include determining, by computing device 12, based on the at least one powder control parameter and at least one component interaction parameter, a mass flux, and controlling, based on the at least one powder control parameter and the mass flux, energy delivery device 16 and powder delivery device 14 to deposit the plurality of layers. The at least one component interaction parameter includes at least one of a part geometry, a melt pool capture capability, or a tool path. Further, the technique may include, by computing device 12, at least one of: determining the part geometry based on a deposit topology; determining the melt pool capture capability based on melt pool size; or determining the tool path based on a build strategy.

Computing device 12 may further determine a quality index, for example, indicative of conformance of component 22 to predetermined tolerances. For example, the technique may further include, by computing device 12, determining, based on the sensor data, at least one process response (108). Computing device 12 may further determine, by comparing the process response with a threshold response value, the quality index (110). The at least one process response may include at least one of a build quality, a build height, or a layer thickness.

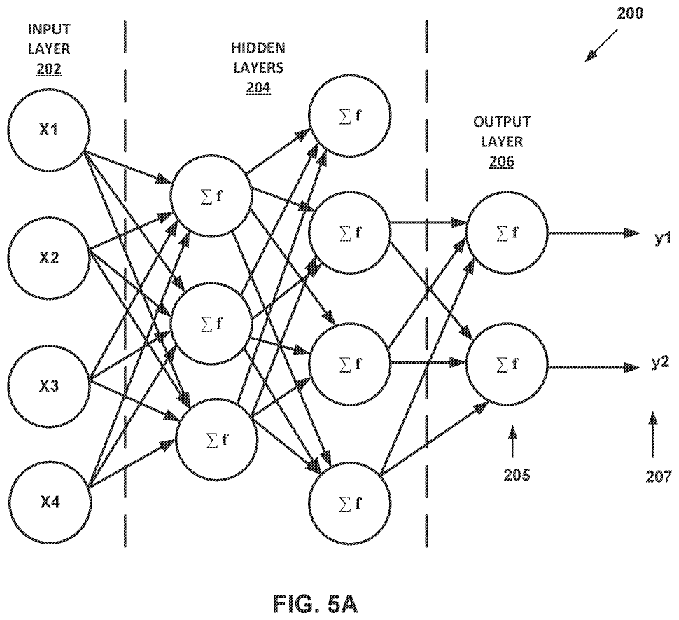

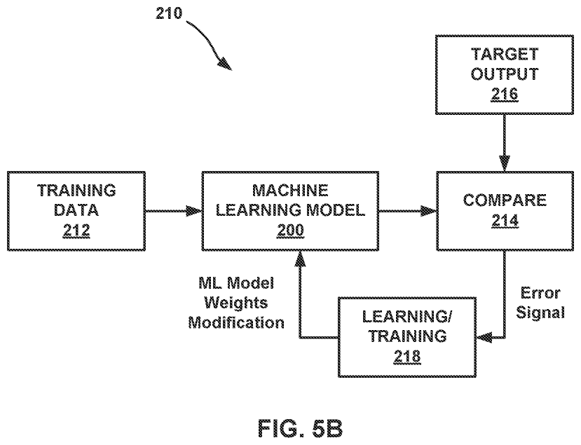

As explained above, additive manufacturing systems described herein may be configured to use machine learning processes for evaluating sensor data to determine at least one powder control parameter and/or adjust the set of deposition parameters for subsequent layers. FIG. 5A is a conceptual diagram illustrating an example machine learning model according to one or more aspects of this disclosure. Machine learning model 200 may be an example of a machine learning model implemented by computing device 12. Machine learning model 200 may be an example of a deep learning model, or deep learning algorithm, trained to determine deposition parameters for subsequent layers. Computing device 12 and/or another device, may train, store, and/or utilize machine learning model 200, but other devices of system 10 may apply inputs to machine learning model 200. In some examples, other types of machine learning and deep learning models or algorithms may be utilized. For example, a convolutional neural network model of ResNet-18 may be used. Some non-limiting examples of models that may be used for transfer learning include AlexNet, VGGNet, GoogleNet, ResNet50, or DenseNet, etc. Some non-limiting examples of machine learning techniques include Support Vector Machines, K-Nearest Neighbor algorithm, and Multi-layer Perceptron.

As shown in the example of FIG. 5A, machine learning model 200 may include three types of layers. These three types of layers include input layer 202, hidden layers 204, and output layer 206. Output layer 206 includes the output from the transfer function 205 of output layer 206. Input layer 202 represents each of the input values X1 through X4 provided to machine learning model 200. In some examples, the input values may include any of the values input into the machine learning model, as described above. For example, the input values may include sensor data from sensor 48, or other data received by computing device 12, as described above. In addition, in some examples input values of machine learning model 200 may include additional data, such as other data that may be collected by or stored in system 200.

Each of the input values for each node in the input layer 202 is provided to each node of a first layer of hidden layers 204. In the example of FIG. 5A, hidden layers 204 include two layers, one layer having four nodes and the other layer having three nodes, but fewer or greater number of nodes may be used in other examples. Each input from input layer 202 is multiplied by a weight and then summed at each node of hidden layers 204. During training of machine learning model 200, the weights for each input are adjusted to establish a relationship between topological data and deposition parameters that generate the layer represented by the topological data. In some examples, one hidden layer may be incorporated into machine learning model 200, or three or more hidden layers may be incorporated into machine learning model 200, where each layer includes the same or different number of nodes.

The result of each node within hidden layers 204 is applied to the transfer function of output layer 206. The transfer function may be linear or non-linear, depending on the number of layers within machine learning model 200. Example non-linear transfer functions may be a sigmoid function or a rectifier function. The output 207 of the transfer function may be a set of deposition parameters that correspond to the layer represented by the topological data and having a desired thickness.

As shown in the example above, by applying machine learning model 200 to input data such as image data, processing circuitry of computing device 12 is able to determine a relationship between deposition parameters that produce a layer based on the sensor data. Computing device 12 may utilize such features to generate a predictive model and/or use the predictive model to determine at least one powder control parameter based on sensor data.

FIG. 5B is a conceptual diagram illustrating an example training process for a machine learning model according to one or more aspects of this disclosure. Process 210 may be used to train machine learning model 200. Machine learning model 200 may be implemented using any number of models for supervised and/or reinforcement learning, such as but not limited to, an artificial neural network, a decision tree, naïve Bayes network, support vector machine, or k-nearest neighbor model, CNN, RNN, LSTM, ensemble network, to name only a few examples.

In some examples, computing device 12 or another device trains machine learning model 100 based on a corpus of training data 212. Training data 212 may include, for example, previous topological data of a build over time, previous deposition parameter data, and/or the like. Previous deposition parameter data, for example, may include deposition parameters associated with previous additive manufacturing processes. In some examples, the sensor data and/or deposition parameter data may be generated by executing a natural language processing application on content of a plurality of operational records to automatically extract relevant nor desired training data. For example, by using an NLP model, computing device 12 may capture potentially cofounding operation conditions or factors, which may be useful in determining a set of deposition parameters. Computing device 12 may use the NLP model to capture such details.

In some examples, training data 212 may include annotations identifying effects of deposition parameters indicated in topological data of training data 212. Training data 212 may include data from past additive deposition processes performed on components having different geometries, formed from different materials, formed under different conditions, and/or the like.

While training machine learning model 200, computing device 12 may compare 214 a prediction or classification with a target output 216. Computing device 12 may utilize an error signal from the comparison to train (learning/training 218) machine learning model 200. Computing device 12 may generate machine learning model weights or other modifications which computing device 12 may use to modify machine learning model 200. For example, computing device 12 may modify the weights of machine learning model 200 based on the learning/training 218.

The following enumerated clauses describe various examples according to the present disclosure.

Clause 1: An additive manufacturing system, including an energy delivery device configured to deliver energy to a build surface of a component to form a melt pool in the build surface of the component; a powder delivery device configured to direct a powder stream toward the melt pool; at least one sensor configured to generate sensor data representative of at least one process characteristic; and a computing device configured to: receive the sensor data from the at least one sensor; determine, based on the sensor data and a predictive model data, at least one powder control parameter configured to achieve a predetermined powder feed rate of the powder stream; and control, based on the at least one powder control parameter, the energy delivery device and the powder delivery device to deposit a plurality of layers.

Clause 2: The additive manufacturing system of clause 1, where the at least one sensor includes at least one of a powder flow monitor, a gas flow sensor, a melt pool monitor, a high speed camera, or a laser diffraction sensor.

Clause 3. The additive manufacturing system of clauses 1 or 2, where the at least one process characteristic includes at least one of a powder flow rate, a carrier gas flow rate, a melt pool size, a powder quality, or a powder velocity.

Clause 4: The additive manufacturing system of any of clauses 1 to 3, where the at least one powder control parameter includes at least one of a powder flow rate, a powder size, a powder density, a powder feeder geometry, a deposition head geometry, a carrier gas flow rate, a powder nozzle geometry, a center purge shielding gas flow rate, a nozzle standoff to substrate distance, a nozzle standoff to build surface distance, or any parameter that may affect the powder stream or powder working spot size, shape, or density profile.

Clause 5: The additive manufacturing system of clause 4, where the computing device is further configured to generate the predictive model data by determining a change in the powder feed rate associated with a change in the at least one powder control parameter.

Clause 6: The additive manufacturing system of any of clauses 1 to 5, where the computing device is further configured to: determine, based on the at least one powder control parameter and at least one component interaction parameter, a mass flux; and control, based on the at least one powder control parameter and the mass flux, the energy delivery device and the powder delivery device to deposit the plurality of layers.

Clause 7: The additive manufacturing system of clause 6, where the at least one component interaction parameter includes at least one of a part geometry, a melt pool capture capability, or a tool path.

Clause 8: The additive manufacturing system of clause 7, where the computing device is configured to determine at least one of the part geometry based on a deposit topology, the melt pool capture capability based on melt pool size, or the tool path based on a build strategy.

Clause 9: The additive manufacturing system of any of clauses 1 to 8, where the computing device is further configured to: determine, based on the sensor data, at least one process response; and determine, by comparing the process response with a threshold response value, a quality index.

Clause 10: The additive manufacturing system of clause 9, where the at least one process response includes at least one of a build quality, a build height, or a layer thickness.

Clause 11: A method for additive manufacturing, including: receiving, by a computing device, sensor data for a plurality of layers from at least one sensor of an additive manufacturing system, where the sensor data is representative of at least one process characteristic; determining, by the computing device, based on the sensor data and a predictive model data, at least one powder control parameter configured to achieve a predetermined powder feed rate of the powder stream; and controlling, by the computing device, based on the at least one powder control parameter, an energy delivery device to deliver energy to a build surface to form a melt pool and a powder delivery device to direct a powder stream toward the melt pool.

Clause 12: The method of clause 11, where the at least one sensor includes at least one of a powder flow monitor, a gas flow sensor, a melt pool monitor, a high speed camera, or a laser diffraction sensor.

Clause 13: The method of clauses 11 or 12, where the at least one process characteristic includes at least one of a powder flow rate, a carrier gas flow rate, a melt pool size, a powder quality, or a powder velocity.

Clause 14: The method of clause 13, where the at least one powder control parameter includes at least one of a powder flow rate, a powder size, a powder density, a powder feeder geometry, a deposition head geometry, a carrier gas flow rate, a powder nozzle geometry, a center purge shielding gas flow rate, a nozzle standoff to substrate distance, a nozzle standoff to build surface distance, or any parameter that may affect the powder stream or powder working spot size, shape, or density profile.

Clause 15: The method of any of clauses 11 to 14, further including, by the computing device, generating the predictive model data by determining a change in the powder feed rate associated with a change in the at least one powder control parameter.

Clause 16: The method of any of clauses 11 to 15, further including, by the computing device: determining, based on the at least one powder control parameter and at least one component interaction parameter, a mass flux; and controlling, based on the at least one powder control parameter and the mass flux, the energy delivery device and the powder delivery device to deposit the plurality of layers.

Clause 17: The method of clause 16, where the at least one component interaction parameter includes at least one of a part geometry, a melt pool capture capability, or a tool path.

Clause 18: The method of clause 17, further including, by the computing device,

at least one of: determining the part geometry based on a deposit topology; determining the melt pool capture capability based on melt pool size; or determining the tool path based on a build strategy.

Clause 19: The method of any of clauses 11 to 18, further including, by the computing device: determining, based on the sensor data, at least one process response; and determining, by comparing the process response with a threshold response value, a quality index.

Clause 20: The method of clause 19, where the at least one process response includes at least one of a build quality, a build height, or a layer thickness.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. An additive manufacturing system, comprising:
an energy delivery device configured to deliver energy to a build surface of a component to form a melt pool in the build surface of the component;
a powder delivery device configured to direct a powder stream toward the melt pool;
at least one sensor configured to generate sensor data representative of at least one process characteristic; and
a computing device configured to:
receive the sensor data from the at least one sensor;
determine, based on the sensor data and a predictive model data, at least one powder control parameter configured to achieve a predetermined powder feed rate of the powder stream; and
control, based on the at least one powder control parameter, the energy delivery device and the powder delivery device to deposit a plurality of layers.

2. The additive manufacturing system of claim 1, wherein the at least one sensor comprises at least one of a powder flow monitor, a gas flow sensor, a melt pool monitor, a high speed camera, or a laser diffraction sensor.

3. The additive manufacturing system of claim 1, wherein the at least one process characteristic comprises at least one of a powder flow rate, a carrier gas flow rate, a melt pool size, a powder quality, or a powder velocity.

4. The additive manufacturing system of claim 1, wherein the at least one powder control parameter comprises at least one of a powder flow rate, a powder size, a powder density, a powder feeder geometry, a deposition head geometry, a carrier gas flow rate, a powder nozzle geometry, a center purge shielding gas flow rate, a nozzle standoff to substrate distance, a nozzle standoff to build surface distance, or any parameter that may affect the powder stream or powder working spot size, shape, or density profile.

5. The additive manufacturing system of claim 4, wherein the computing device is further configured to generate the predictive model data by determining a change in the powder feed rate associated with a change in the at least one powder control parameter.

6. The additive manufacturing system of claim 1, wherein the computing device is further configured to:
determine, based on the at least one powder control parameter and at least one component interaction parameter, a mass flux; and
control, based on the at least one powder control parameter and the mass flux, the energy delivery device and the powder delivery device to deposit the plurality of layers.

7. The additive manufacturing system of claim 6, wherein the at least one component interaction parameter comprises at least one of a part geometry, a melt pool capture capability, or a tool path.

8. The additive manufacturing system of claim 7, wherein the computing device is configured to determine at least one of the part geometry based on a deposit topology, the melt pool capture capability based on melt pool size, or the tool path based on a build strategy.

9. The additive manufacturing system of claim 1, wherein the computing device is further configured to:
determine, based on the sensor data, at least one process response; and
determine, by comparing the process response with a threshold response value, a quality index.

10. The additive manufacturing system of claim 9, wherein the at least one process response comprises at least one of a build quality, a build height, or a layer thickness.

11. A method for additive manufacturing, comprising:
receiving, by a computing device, sensor data for a plurality of layers from at least one sensor of an additive manufacturing system, wherein the sensor data is representative of at least one process characteristic;
determining, by the computing device, based on the sensor data and a predictive model data, at least one powder control parameter configured to achieve a predetermined powder feed rate of the powder stream; and
controlling, by the computing device, based on the at least one powder control parameter, an energy delivery device to deliver energy to a build surface to form a melt pool and a powder delivery device to direct a powder stream toward the melt pool.

12. The method of claim 11, wherein the at least one sensor comprises at least one of a powder flow monitor, a gas flow sensor, a melt pool monitor, a high speed camera, or a laser diffraction sensor.

13. The method of claim 11, wherein the at least one process characteristic comprises at least one of a powder flow rate, a carrier gas flow rate, a melt pool size, a powder quality, or a powder velocity.

14. The method of claim 13, wherein the at least one powder control parameter comprises at least one of a powder flow rate, a powder size, a powder density, a powder feeder geometry, a deposition head geometry, a carrier gas flow rate, a powder nozzle geometry, a center purge shielding gas flow rate, a nozzle standoff to substrate distance, a nozzle standoff to build surface distance, or any parameter that may affect the powder stream or powder working spot size, shape, or density profile.

15. The method of claim 11, further comprising, by the computing device, generating the predictive model data by determining a change in the powder feed rate associated with a change in the at least one powder control parameter.

16. The method of claim 11, further comprising, by the computing device:
determining, based on the at least one powder control parameter and at least one component interaction parameter, a mass flux; and
controlling, based on the at least one powder control parameter and the mass flux, the energy delivery device and the powder delivery device to deposit the plurality of layers.

17. The method of claim 16, wherein the at least one component interaction parameter comprises at least one of a part geometry, a melt pool capture capability, or a tool path.

18. The method of claim 17, further comprising, by the computing device, at least one of:
determining the part geometry based on a deposit topology;
determining the melt pool capture capability based on melt pool size; or
determining the tool path based on a build strategy.

19. The method of claim 11, further comprising, by the computing device:
determining, based on the sensor data, at least one process response; and
determining, by comparing the process response with a threshold response value, a quality index.

20. The method of claim 19, wherein the at least one process response comprises at least one of a build quality, a build height, or a layer thickness.
